(19) United States
(12) Patent Application Publication
(10) Pub. No.: US 2009/0276249 A1
(43) Pub. Date: Nov. 5, 2009

(54) Method and system for providing healthcare insurance

(76) Inventors: Larry R. Dust, Indianapolis, IN (US); David B. Cook, Indianapolis, IN (US); Wallace T. Gray, Carmel, IN (US); Hans F. Kraabel, Carmel, IN (US)

Correspondence Address: BAKER & DANIELS LLP, 300 NORTH MERIDIAN STREET, SUITE 2700, INDIANAPOLIS, IN, 46204, US

(21) Appl. No.: 12/459,722

(22) Filed: Jul. 7, 2009

Related U.S. Application Data
(63) Continuation of application No. 10/911,324, filed on Aug. 4, 2004, now abandoned.
(60) Provisional application No. 60/568,557, filed on May 6, 2004.

(51) Int. Cl. G06Q 40/00; G06Q 50/00

(52) U.S. Cl. 705/4; 705/35

(57) ABSTRACT

A method and system for providing healthcare benefits according to the present invention may include a proposed healthcare plan having a primary component, a supplemental component, and a procedure for optimizing services consumption which is presented and customized “on-the-fly” to benefits providers, such as employers, and administered in an efficient manner that reduces the claims processing burden on individuals or families covered under the proposed plan.

### RELATED APPLICATIONS

The present application is a continuation of and claims priority to U.S. patent application Ser. No. 10/911,324, filed on Aug. 4, 2004, which is based on Provisional Patent Application Ser. No. 60/568,557, which was filed on May 6, 2004, the entire disclosures of which are hereby incorporated herein by reference.

### FIELD OF THE INVENTION

The present invention generally relates to methods and systems for providing healthcare insurance, and more specifically to methods and systems for demonstrating the financial impact of insurance plans having supplemental insurance components and methods and systems for providing such insurance plans.

### BACKGROUND OF THE INVENTION

Employer sponsored healthcare benefits are of tremendous value to employees and their families. Such benefits, on the other hand, typically constitute a significant portion of an employer's total operating costs. Moreover, the costs of providing healthcare benefits are rapidly increasing and extremely difficult to control. Currently, the projected medical inflation rate through the end the decade is approximately 14%. As such, the average cost an employer will incur to provide medical benefits to a single employee will be approximately $12,000 in 2010. It is widely recognized that employers view control of healthcare costs as a very high corporate priority, but few are confident in their ability to gain such control.

Currently, some employers attempt to offset the rising costs of providing healthcare benefits by simply shifting a portion of the costs to the employees. This approach alone is generally undesirable because increased employee costs or benefit reductions may affect employee morale and be considered inconsistent with the objectives and culture of the employer. Of course, as a practical matter only so much of the expense can be shifted to employees. At some point, the cost incurred by the employees will become prohibitive, and employer sponsored healthcare will no longer be seen as a benefit.

Some employers purchase supplemental insurance to offset decreases in employee benefits resulting from the employer's efforts to reduce costs associated with a primary healthcare plan. Typically, such supplemental insurance covers a portion of claims amounts no longer covered by the “scaled back” primary plan. It is, however, difficult for employers to fully understand the effects changes in their healthcare plan will have on the bottom line, as well as on the benefits of their employees. By changing plan variables such as deductibles, coinsurance percentages and coinsurance maximums, the costs to the employer can be dramatically affected, as can the employees' benefits. Without a clear demonstration of the effects of each of these and other variables, the employer cannot make a fully informed decision regarding customization of a current healthcare plan.

Other employers attempt to reduce the costs of providing healthcare benefits by monitoring the price of certain healthcare services. Without information relating to the quality of the services, however, cost information is of limited value. Other cost reduction attempts include sponsorship of health fairs or wellness screenings. This approach may promote preventative healthcare, but is not a focused expenditure of resources as most of the employees that attend wellness screenings are healthy. Finally, employers sometimes attempt to negotiate the fixed costs associated with administering healthcare benefits. Again, since these costs typically make up only a small portion of the total cost, even successful negotiation attempts will have a limited impact on the employer's bottom line.

Finally, another aspect of conventional healthcare plans that can add a layer of cost and complexity is the procedure for processing claims. Many conventional plans require substantial involvement of employees to ensure that claims are paid either entirely through the plan, or partially by the plan and partially by the employee. This burden on employees is undesirable because it decreases the perceived benefit of the plan to the employees.

In short, employers have been largely unsuccessful in their attempts to control healthcare costs while ensuring a high level of care. Employers simply lack the information necessary to identify the most significant factors affecting their healthcare costs, to understand the impact of changes to their healthcare plans, to quantify and compare the performance of healthcare providers, and to apply their resources in a way that most effectively reduces the overall consumption of healthcare, the costs of the services consumed, and the complexity of claims processing from the employee's perspective while maintaining or improving the quality of the healthcare benefits they provide.

### SUMMARY OF THE INVENTION

The present invention provides methods and systems for customizing a healthcare plan having a supplemental insurance component and demonstrating the financial impact of the proposed plan. In other embodiments, the present invention incorporates a healthcare consumption optimization method for analyzing demographic and wellness characteristics of an employee population, as well as the quality and cost efficiency of the practices of providers used by the employees, and providing intervention with employees and providers to improve the overall health of the employees, the practices of the providers, and the cost efficiency of the primary component of the employer's healthcare plan. In another embodiment of the present invention, various structures for administering proposed plans are provided for streamlining claims processing.

The features and advantages of the present invention described above, as well as additional features and advantages, will be readily apparent to those skilled in the art upon reference to the following description and the accompanying drawings.

### BRIEF DESCRIPTION OF THE DRAWINGS

FIG. 1 is a table providing characteristics of a conventional healthcare plan and a plan according to the present invention as implemented over a three-year period.

FIG. 2 is a chart depicting the manner in which benefits are provided under both a conventional healthcare plan and a plan according to the present invention.

FIG. 3 is a chart depicting the differences in cost of a conventional healthcare plan and a plan according to the present invention over a three-year period.

FIG. 4 is a chart demonstrating the financial impact of the order in which claims are processed under a conventional plan and a plan according to the present invention.

FIG. 5 is a chart depicting the distribution of costs and savings to employees covered under a plan according to the present invention.

FIG. 6 is a table of actuarial relativity factors.

FIG. 7 is a flow chart depicting a method of presenting a healthcare plan according to the present invention.

FIG. 8 is a table depicting the differences over a three-year period of the costs of a conventional healthcare plan and a plan having a primary and supplemental component, and incorporating a healthcare consumption optimization service according to the present invention.

FIG. 9 is a conceptual diagram of a prior art structure for administering healthcare benefits.

FIGS. 10-12 are conceptual diagrams of structures for administering healthcare plans according to the principles of the present invention.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

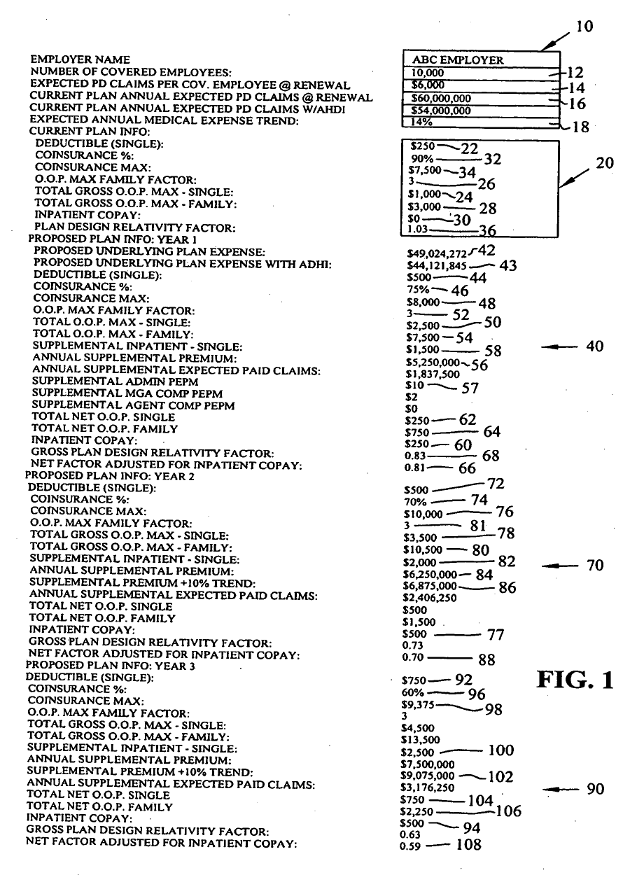

The basic characteristics of a medical plan according to the present invention are described with reference to FIG. 1, which contrasts current (or conventional) plan characteristics of an employer (hereinafter “the current plan”) with the characteristics of a proposed plan using supplemental insurance (hereinafter “the proposed plan”) as implemented over three years. It should be understood that throughout this disclosure, the term “employer” is intended to encompass any entity, public or private, that provides healthcare benefits to a group of individuals (employees or others) and their families, whether the benefits are provided through a fully-insured plan or a self-funded plan. As shown in box 10, the sample employer, “ABC Employer, Inc.,” (hereinafter “the employer”) requires coverage on 10,000 employees (cell 12). Based on historical claims data, it is determined that the annual expected amount of paid claims (either paid by the employer in a self-funded plan, or by an insurance carrier in a fully-insured plan) for each employee is $6,000 (cell 14). Based on these numbers, the annualized expected cost of the current plan will be $60,000,000 (10,000 employees times $6,000 per employee) for the upcoming plan year (cell 16). As will be further explained below, a 14% annual increase (cell 18) in medical expenses is assumed (cell 18) for purposes of projecting savings under a proposed plan according to the present invention.

Box 20 includes information regarding the current plan of the employer. Individuals under the current plan pay an annual deductible of $250 (cell 22) and can incur an annual maximum out-of-pocket expense (“MOOPE”) of $1,000 (cell 24). A multiplier of 3 (cell 26) is used to determine an annual family MOOPE of $3,000 (cell 28). Under the current plan, employees have no co-pay requirement for inpatient claims (cell 30). The current plan provides a 90% coinsurance level (cell 32) on the first $7,500 of eligible claims (cell 34). Accordingly, after the employee pays the $250 deductible, the employer will pay $6,750 of the first $7,500 of eligible claims, and the employee will pay $750. At that point, the employee will have reached his or her MOOPE ($250 deductible plus $750 coinsurance payments equals $1,000 MOOPE). If claims within a plan year exceed $7,500 for that employee, then the employer pays 100% of the amounts in excess of $7,500, less any co-pays for which the employee is responsible. For families covered under the current plan, each family member incurs a $250 deductible, and pays coinsurance on eligible claims until either that family member reaches his or her MOOPE or the entire family reaches the family MOOPE of $3,000, after which the employer pays 100% of expenses, less co-pays. As will be further described below, the relativity factor for a plan having the above-described characteristics is 1.03 (cell 36).

Box 40 includes information regarding a proposed plan for the employer according to the principles of the present invention, which includes a primary plan component and a supplemental plan component. Assuming constant healthcare utilization levels, the total expense for the primary plan during its first year will be $49,024,272 cell 42). As indicated in cell 44, the employee's deductible is $500, a $250 increase over the current plan. Also, the coinsurance level is decreased to 75% (cell 46) and the coinsurance maximum is increased to $8,000 (cell 48). Accordingly, from the employee's perspective, the primary plan requires a higher deductible, pays a lower percentage of the costs of eligible claims, and increases the cutoff for coinsurance (the level at which the employee enjoys 100% coverage by the employer). Before reductions resulting from the supplemental plan (as explained below), the employee's gross MOOPE (cell 50) using the same calculation as described above, is $2,500 (i.e., the employee's $500 deductible, plus 25% of the coinsurance maximum of $8,000). The same family factor multiplier of 3 (cell 52) is used in the proposed plan, thereby resulting in a family MOOPE of $7,500 (cell 54).

As should be apparent from the foregoing, the primary plan component of the proposed plan is less desirable than the current plan from the employee's perspective. Conversely, because the primary plan includes a higher deductible, a lower coinsurance percentage, and a higher coinsurance maximum, it is less expensive for the employer. As a practical matter, however, the employer may not desire the primary plan alone, notwithstanding the cost savings, because it would represent a significant shift in costs to the employees and provide reduced benefits, both of which employer may view as contrary to its obligations to its employees, detrimental to employee morale, or otherwise unfair or undesirable. Accordingly, the proposed plan also includes a supplemental insurance component which greatly reduces the burden on the employees (in fact, providing a reduction in healthcare costs for most employees) while still resulting in a substantial cost savings for employer.

As shown in Box 40 of FIG. 1, for an annual premium of $5,250,000 (cell 56), the employer may purchase supplemental insurance that, depending upon the healthcare utilization characteristics of the employee, covers all of the shortfall (from the employee's perspective) of the primary plan, provides greater benefits than the current plan, and still saves the employer a substantial amount in healthcare expenses. The premium amount is consistent with the prevailing rates of other plans if the employer is fully insured, or based on past claims history (plus administrative fees), if the employer has a self-funded plan. As shown in cell 58, the supplemental insurance pays up to a $1,500 benefit for eligible inpatient claims of an individual, but requires a $250 inpatient co-pay (cell 60). As is further described below, the outpatient benefit is $750.00 (not shown). Generally, the outpatient benefit is automatically calculated as 50% of the inpatient benefit. It should be understood, however, that the outpatient benefit could readily be a variable in the proposed plan. As will be described in greater detail below, the total net MOOPE for individuals and families is $250 and $750, respectively (cells 62 and 64). The relativity factor for the proposed plan is approximately 0.81 (cell 66) after adjustment for the inpatient co-pay. The supplemental plan assumes a reduction of 2% in the relativity factor for each $300 of inpatient co-pay. Here, a $250 in inpatient co-pay reduces the gross plan relativity factor of 0.83 (cell 68) by 1.67%.

It should be understood that certain claims may be excluded (i.e., ineligible claims) from the supplemental component including, for example, mental and nervous conditions, alcoholism or drug abuse claims, prescription drugs, chemotherapy/radiation received on an outpatient basis, emergency room visits due to illness, etc. In this manner, the proposed plan effectively encourages wellness of employees and efficient healthcare utilization. For example, if emergency room visits for routine illnesses are excluded, employees will have incentive to use more appropriate services and reserve emergency room visits for true emergencies.

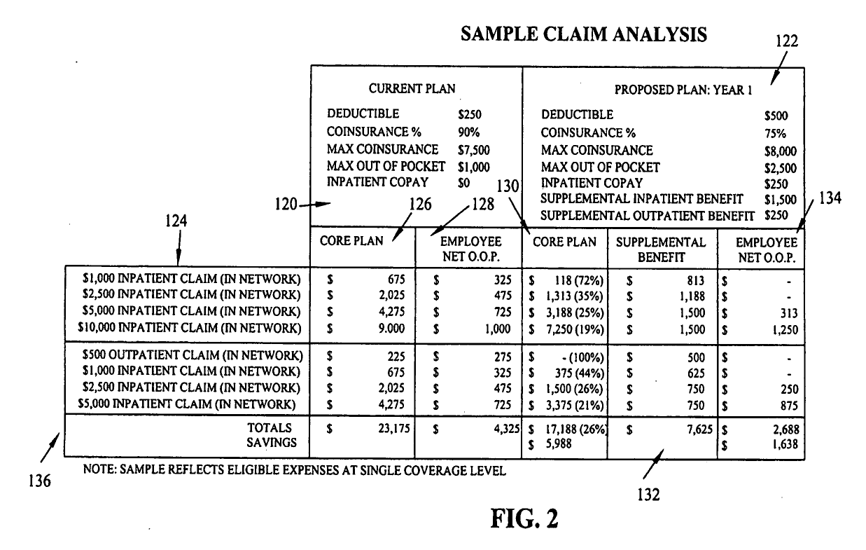

Referring now to FIG. 2, a sample claim analysis chart is provided to compare the treatment of various types of claims for eligible expenses for individual employees. Box 120 includes the above-described characteristics of the current plan, and box 122 includes the above-described characteristics of the proposed plan (for the first year). Column 124 lists inpatient and outpatient claims for various amounts. Column 126 shows the amount of the claim of column 124 that is paid by the employer under the current plan, and column 128 shows the amount the employee pays under the current plan (including the $250 deductible). Column 130 shows the amount of the claim that is paid by the employer under the primary component of the proposed plan, as well as the percent savings (in parenthesis) versus the number in column 126. Column 132 shows the amount of the claim that is paid by the supplemental component of the proposed plan. Finally, column 134 shows the amount of the claim paid by the employee.

Referring to the $1,000 inpatient claim listed in column 124, under the current plan, the employer pays $675 (i.e., 90% of the $750 claim remaining after the employee pays the $250 deductible). As shown in column 128, the employee pays the $325 remainder (i.e., the $250 deductible, plus $75 (10% of the $750 claim remaining after the deductible)). In contrast, under the proposed plan the employer pays only $188 (i.e., 75% of the $250 claim remaining after the employee's $500 deductible and $250 inpatient co-pay) and the employee pays nothing because the supplemental insurance covers the deductible and co-pay, as well as the employee's $63 co-insurance payment (i.e., a total of $813).

As indicated by the numbers associated with the $5,000 and $10,000 inpatient claims listed in column 124, single or cumulative claims that exceed a certain amount in a year require the employee to pay at least a portion of the employee's MOOPE under the proposed plan. For example, under the current plan, the employer pays $9,000 of the $10,000 claim, while the employee pays $1,000 (i.e., the employee's MOOPE). The employer's share is computed by first subtracting the $250 deductible from the $10,000 amount, leaving $9,750. The first $7,500 of the $9,750 amount is paid at the 90% coinsurance level by the employer, for an employer payment of $6,750. Since, at this point, the employee has paid the MOOPE of $1,000, the remainder of the $9,750 amount (i.e., $2,250) is paid 100% by the employer. Thus, the employer's total payment under the current plan is $9,000 (i.e., $6,750 plus $2,250).

Under the proposed plan, the employer pays 75% up to $8,000 of the $10,000 claim amount remaining after the employee pays the $500 deductible and the $250 inpatient co-pay, until the employee reaches the employee's MOOPE, after which the employer pays 100%. In this example, the employer would pay 75% of $8,000 of the $9,250 remaining after the deductible and co-pay, or $6,000. The employee would (absent supplemental insurance) pay 25% of $8,000, or $2,000. The employer pays 100% of the $1,250 above the $8,000 co-insurance maximum. Accordingly, the employer's total payment is $6,000 plus $1,250 or $7,250. The employee's responsibility, absent supplemental insurance, is $2,750 ($500 deductible, $250 in-patient co-pay, and $2,000 co-insurance payment). This amount, however, is substantially offset by the $1,500 inpatient benefit of the supplemental plan. Although the employee's net responsibility of $1,250 is greater than the employee's MOOPE under the current plan, a relatively small number of employees incur such large claims.

Referring now to the $500 entry of the outpatient claims row of FIG. 2, under the current plan, the employer pays $225 (i.e., 90% of the $250 remaining after reduction by the employee's $250 deductible), and the employee pays $275 (i.e., the $250 deductible, plus $25 (10% of the $250 remaining after the $250 deductible)). Under the proposed plan, the employer pays nothing because the employee's deductible is $500. The employee also pays nothing because the supplemental insurance pays up to $750 of eligible outpatient claims.

Referring to the $2,500 outpatient claim entry of column 124, under the current plan calculations, the employer pays $2,025 and the employee pays $475. Under the proposed plan, the employer pays only $1,500 (75% of the $2,000 remaining after the $500 deductible), the supplemental insurance pays $750 (the full outpatient benefit), and the employee pays the remaining $250 as an out-of-pocket expense. As shown in the bottom row 136 of FIG. 2, for the sample claims of eight individuals listed in column 124, the employer realizes a savings of $5,988 (26%) and the employees realize a cumulative savings of $1,638 (38%).

Referring back to FIG. 1, as part of the present invention, a three-year proposed plan package is provided to project financial data and provide a basis for healthcare cost budgeting. It should be understood, however, that projections according to the present method may encompass a time period of greater or less than three years. More specifically, as indicated in box 70, a proposed plan for year 2 is different in several respects from the proposed plan for year 1. As shown, while the deductible remains $500 (cell 72), the coinsurance percentage is decreased from 75% to 70% (cell 74), the co-insurance maximum is increased from $7,500 to $10,000 (cell 76), and the inpatient co-pay is increased from $250 to $500 (cell 77). Accordingly, the gross single MOOPE is increased from $2,500 to $3,500 (cell 78) (i.e., $500 deductible plus $3,000 (30% of the $10,000 coinsurance maximum)), and the gross family MOOPE is increased proportionately (cell 80) as the family multiplier of 3 (cell 81) remains the same. To offset these increased costs from the employee's perspective, the supplemental insurance amounts are increased to provide an inpatient benefit of $2,000 (cell 82) instead of $1,500, and an outpatient benefit of $1,000 (not shown) instead of $750. Of course, the employer must pay a higher premium for the increased supplemental insurance benefits. Thus, the supplemental insurance premium is increased to $6,250,000 (cell 84) as priced using current dollars. Assuming a trend of 10% annual increases in supplemental insurance premiums, the actual supplemental insurance premium in year 2 is $6,875,000 (cell 86). The relativity factor corresponding to these plan characteristics after adjustment for the $500 inpatient co-pay is 0.70 (cell 88).

Referring now to the proposed plan year 3 shown in box 90 of FIG. 1, the employee deductible increases from $500 to $750 (cell 92), the inpatient co-pay remains at $500 (cell 94), the coinsurance percentage is decreased from 70% to 60% (cell 96), and the co-insurance maximum is decreased slightly to $9,375 (cell 98). The supplemental insurance benefits are increased, however, from $2,000 to $2,500 (cell 100) for individual inpatient claims, from $1,000 to $1,250 (not shown) for individual outpatient claims, and from $6,000 to $7,500 (not shown) for the family benefit. Consequently, the cost of the supplemental insurance is projected as increasing to $9,075,000 (cell 102) after accounting for the 10% annual trend. The net MOOPE for single employees is $750 (cell 104) and $2,250 (cell 106) for families. The relativity factor corresponding to these plan characteristics after adjustment for the $500 inpatient co-pay is 0.59 (cell 108).

In all of the years of the proposed plan, the employee's net MOOPE is non-zero, but still lower than the MOOPEs of the current plan. In year three, an individual employee who generates $9,375 in eligible healthcare claims, half of which are for inpatient services, will pay a net MOOPE of $750. More specifically, the employee's net MOOPE of $4,500 ($750 deductible plus $3,750 (40% of the maximum coinsurance amount of $9,375)) is reduced by $3,750 in total supplemental insurance benefits ($2,500 inpatient benefit plus $1,250 outpatient benefit), leaving $750 to be paid by the employee. Similar calculations result in a net family MOOPE of $2,250.

It should be understood that all of the above-described characteristics are fully adjustable to fit the employer's situation. As will be explained below, the proposed plans result in substantial savings for the employer. Many employer's, however, may choose to pass some or even all of this savings on to the employees in the form of lower deductibles, higher coinsurance percentages, lower coinsurance maximums, higher supplemental insurance benefits, or any combination thereof. Accordingly, the method of the present invention and the resulting proposed plans may be customized to suit an employer's objectives and benefits environment. Indeed, as is further explained herein, the plans may be customized “on-the-fly” as they are explained to an employer, and the financial impact of each iteration of customization may be displayed to the employer in terms of dollars saved. In this manner, the employer can select a savings level and the characteristics of the proposed plans can be adjusted to provide that savings level.

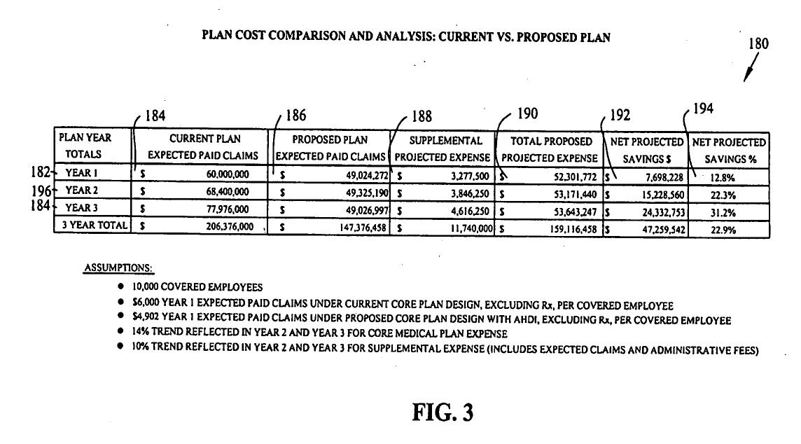

Referring now to FIG. 3, table 180 shows the projected financial impact from the employer's perspective of implementation of the three-year proposal described above. Row 182 summarizes the first year projections. Cell 184 shows the expected cost of $60,000,000 for the current plan during the upcoming year. Cells 186 and 188 show the costs of the primary component and the supplemental component of the proposed plan, respectively. The total cost of $52,301,772 for the first year of the proposed plan is shown in cell 190. Cells 192 and 194 show the savings provided by the proposed plan in dollars ($7,698,228 in cell 192) and percentage (12.8% in cell 194).

The numbers included in box 180 assume that healthcare utilization of the covered employee's will be the same during all three years of the proposed plan as it was during the current year. If utilization increases, the employer's savings will also increase because the corresponding increased cost of the current plan would be greater than the increased cost of the proposed plan.

Conversely, if healthcare utilization decreases during the first year, the employer's savings percentage decreases under the proposed plan as compared to the current plan. Nonetheless, the proposed plan provides a savings at all levels of utilization above approximately fifty percent. It should be understood that in most organizations, especially organizations having a sufficiently large number of employees, fifty percent decreases (or increases for that matter) in healthcare utilization are highly unlikely. Generally, the utilization percentage of very large organizations remains substantially constant from year to year. It should be noted as well that while the proposed plan does not provide a savings over the current plan if healthcare utilization decreases by fifty percent during the first year, the employer's healthcare costs are still approximately one-half the expected cost (assuming a utilization of 1.00) under the current plan.

Row 196 of table 180 summarizes the second year projections of the three-year proposal. As shown, the expected cost of the current plan (assuming a constant healthcare utilization level) is $68,400,000 (the $60,000,000 cost of year one increased by the 14% expected annual medical expense trend mentioned above). The cost of the primary component of the proposed plan increases to $49,325,190 because the coinsurance maximum increased), and the cost of the supplemental insurance component increases to $3,846,250 because the benefits provided by the supplemental component are increased). Accordingly, the employer's overall cost of the proposed plan increases to $53,171,440, but nonetheless represents a 22.3% savings over the expected cost of the current plan. Similarly, as shown in row 198 of table 180, the numbers for the third year show a substantial (i.e., 14%) increase in the cost of the current plan, a decrease in the cost of the primary component of the proposed plan (because deductibles are increased, the co-insurance percentage is decreased, and the co-insurance maximum is decreased), an increase in the cost of the supplemental component (because the supplemental benefits are increased), and an overall savings increase to 31.2%. Over the three-year period reflected in table 180, the employer will have realized a 22.9% savings over the current plan.

The numbers in table 180 demonstrate a beneficial characteristic of implementation of the proposed plan in addition to cost savings. More specifically, the numbers show that, under the proposed plan, the expected healthcare costs are relatively constant over the three-year period (a 2.56% change), thereby reducing the unpredictability of healthcare expenses associated with conventional plans. The relative “flatness” of the overall costs of the proposed plan results from the fact that the primary component is designed to remain nearly constant. To compensate for the reduced benefits (over time) provided by the primary component, the supplemental benefits are increased. The corresponding increase in cost of the supplemental component does not, however, have a significant affect on the overall cost of the proposed plan because the supplemental component is substantially smaller than the primary component.

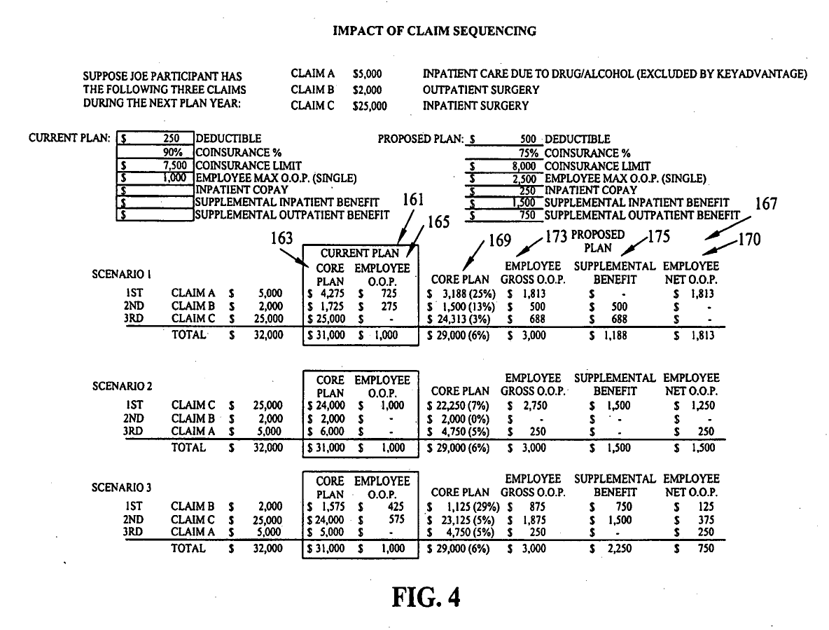

FIG. 4 demonstrates a feature of the proposed plan which provides a portion of the cost savings to the employer. More specifically, FIG. 4 shows three sample claims (claims A, B, and C) for an individual covered under the proposed plan, and three scenarios (scenario 1, 2, and 3) each demonstrating the occurrence of the three claims in one plan year in different sequences. As shown in current plan box 161, the order of occurrence of the claims under the current plan has no effect on the total cost to the employer (column 163) or to the employee (column 165). Similarly, box 167 shows that the sequence of the claims does not affect the total cost to the employer (column 169) under the proposed plan. The sequence does, however, affect the net out-of-pocket costs of the employee (column 171).

As indicated at the top of FIG. 4, claim A is an inpatient claim of $5,000 for a drug/alcohol related condition, which is not covered under the supplemental component of the proposed plan. Claim B is a $2,000 outpatient surgery claim, and claim C is a $25,000 inpatient surgery claim, neither of which is excluded from coverage under the supplemental component of the proposed plan.

Looking first at scenario 1, claim A is processed first. Under the proposed plan of box 167, after the employee's $500 deductible and $250 inpatient copay, the primary plan pays 75% of $4,250, or $3,188. The employee's gross out-of-pocket expense of $1,813 (column 173) corresponds to the remainder (i.e., $500 deductible, plus $250 copay, plus 25% of $4,250). As claim A is excluded from the supplemental plan, the employee's net out-of-pocket expense is also $1,813 as shown in column 171. When claim B is presented, the employee's deductible has been paid, and the coinsurance limit has not yet been reached. Thus, the primary plan simply pays 75% of the $2,000 claim and the employee's gross out-of-pocket expense is 25% of $2,000 or $500. This entire amount, however, is covered by the supplemental plan's outpatient benefit, leaving a zero net payment due from the employee. After the $250 copay is subtracted from claim C, $24,750 remains. As a combined $6,250 toward the coinsurance limit resulted from claims A and B, $1,750 of the $24,750 is paid at 75%, and the remaining $23,000 is paid at 100% under the primary plan. Accordingly, the primary plan pays $24,313, and the employee pays the balance of $688 (i.e., $250 copay plus $438 (25% of $1,750)). The supplemental inpatient benefit, however, covers this entire amount. Thus, in scenario 1, the employee's total net out-of-pocket expense is $1,813.

In scenario 2, claim C is processed first. After the employee's deductible and copay, a $24,250 claim remains, $8,000 of which is covered at the 75% coinsurance level, and $16,250 of which is paid 100% by the primary plan. Accordingly, the primary plan pays $22,250 and the employee's gross out-of-pocket responsibility is the remainder, or $2,750. This amount is offset by the supplemental inpatient benefit of $1,500, leaving a net out-of-pocket payment of $1,250. As the coinsurance limit has already been reached when claim B is processed, the entire claim is paid under the primary plan. Similarly, claim A is paid entirely by the primary plan after the employee pays another inpatient copay of $250. Thus, the employee's total out-of-pocket expense in scenario 2 is $1,500.

In scenario 3, the outpatient surgery claim B is presented first. After the employee's $500 deductible, the primary plan pays 75% of $1,500, or $1,125. The employee's gross out-of-pocket expense is the remaining $875 (i.e., $500 deductible plus 25% of $1,500). The supplemental component of the proposed plan provides a $750 outpatient benefit, reducing the employee's net out-of-pocket payment to $125. Next, the $25,000 inpatient claim is presented. After the employee's $250 copay, a claim of $24,750 remains. As the $1,500 portion of claim A (after the employee's deductible) was applied toward the $8,000 coinsurance limit, the remaining coinsurance amount is $6,500. With that amount paid at 75%, and the remainder of the $24,750 paid at 100%, the primary plan pays $23,125 of claim C. The employee's gross out-of-pocket expense is $1,875 (i.e., $250 copay plus 25% of $6,500). This is reduced by the $1,500 inpatient benefit under the supplemental plan. Thus, the employee's net out-of-pocket payment is $375. Finally, claim A is presented. As the coinsurance maximum has been exceeded, all of the $5,000 claim (less the employee's $250 inpatient copay) is paid by the primary plan at 100%. The supplemental plan provides no benefit to offset the $250 copay because (1) claim A is excluded from coverage under the supplemental plan, and (2) even if it were not excluded, the entire $1,500 inpatient benefit has already been provided. Accordingly, the employee's net out-of-pocket expense under scenario 3 is only $750.

As should be apparent from the foregoing, a portion of the savings provided under the proposed plan results from the fact that the sequence of processing of claims will result, on average, in higher employee costs. As shown in scenario 3, some sequences will result in a lower cost to the employee. Others, however, such as scenario 1 and 2, will result in a higher i5 cost simply based on when the coinsurance limit is reached and whether the claims are excluded.

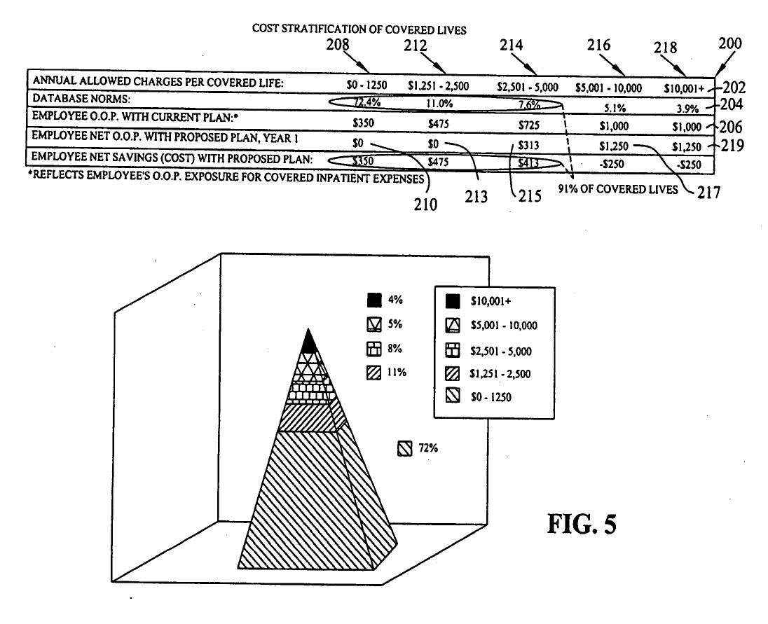

FIG. 5 demonstrates another underlying characteristic of the proposed plan: even as the employer saves money under the proposed plan, a large majority of employees also save. The bottom portion of FIG. 5 shows a distribution of healthcare utilization based on historical claims data. As shown, approximately 72% of employees can be expected to submit annual eligible claims of less than $1,250. Approximately 11% of employees will fall into the $1,250 to $2,500 bracket, while approximately 8% will have eligible claims between $2,500 and $5,000. Only about 5% of employees will have eligible claims between $5,000 and $10,000, and only about 4% will have claims in excess of $10,000. These ranges and percentages are also shown in the table portion 200 of FIG. 5 in row 202 and row 204, respectively.

As shown in row 206 of table 200, under the current plan, employees falling into the range of column 208 will incur an out-of-pocket expense of between zero and $350. As should be understood from the foregoing, the $350 expense corresponds to claims of $1,250 and consists of a $250 deductible plus $100 (10% of the remaining $1,000 claims amount after the deductible). As shown in cell 210 of column 208, under the proposed plan, all employees falling into the range of column 208 will incur zero out-of-pocket expenses, regardless of whether the claims are for inpatient services or outpatient services. Even at the $1,250 end of the range, the $500 deductible required by the proposed plan, the possible $250 inpatient co-pay, and the coinsurance payment of $125 (25% of the remaining $500 claim amount after the deductible and inpatient co-pay) is paid by the supplemental benefits provided under the proposed plan. Similarly, employees falling into the range of column 212 pay between $350 and $475 under the current plan and nothing under the proposed plan (cell 213). Under the proposed plan, if the entire $2,500 at the high end of the range is for eligible inpatient services, then the employee would pay the $500 deductible, the $250 inpatient co-pay, and a coinsurance payment of $438 (25% of the remaining $1,750 claims amount after the deductible and co-pay), for a total expense of $1,188. However, the inpatient supplemental benefit of $1,500 fully covers the employee's costs. Of course, if the $2,500 claims amount consists of a combination of inpatient and outpatient claims, then it may be covered by a combination of the $1,500 inpatient benefit and the $750 outpatient benefit.

In the range of column 214, employees will pay between $475 and $725 under the current plan (deductible plus coinsurance). Under the proposed plan, for a $5,000 eligible inpatient claim, the employee would pay the $500 deductible, the $250 inpatient co-pay, and a coinsurance payment of $1,063 (25% of the remaining $4,250 claims amount after the deductible and the co-pay), for a total expense of $1,813. The $1,500 supplemental benefit, however, reduces the employee's out-of-pocket expense to $313 (cell 215), which is still a substantial savings over the current plan.

As shown in columns 216 and 218, under the current plan employees having claims in these ranges will pay their MOOPE of $1,000. Assuming all eligible inpatient claims, under the proposed plan, employees in these ranges with claims of $7,750 or more will also reach their gross MOOPE of $2,500. This amount, however, will be offset by the $1,500 inpatient benefit of the supplemental insurance, leaving a net expense of $1,250 (cells 217, 219), slightly higher than the corresponding expense under the current plan.

Thus, based on the expected stratification of claims depicted in the lower portion of FIG. 5, an employer can expect that approximately 91% of its employees will actually enjoy a reduction in healthcare expenses for eligible inpatient claims during the first year of the proposed plan while the employer simultaneously enjoys a substantial savings (approximately 13%) in healthcare costs.

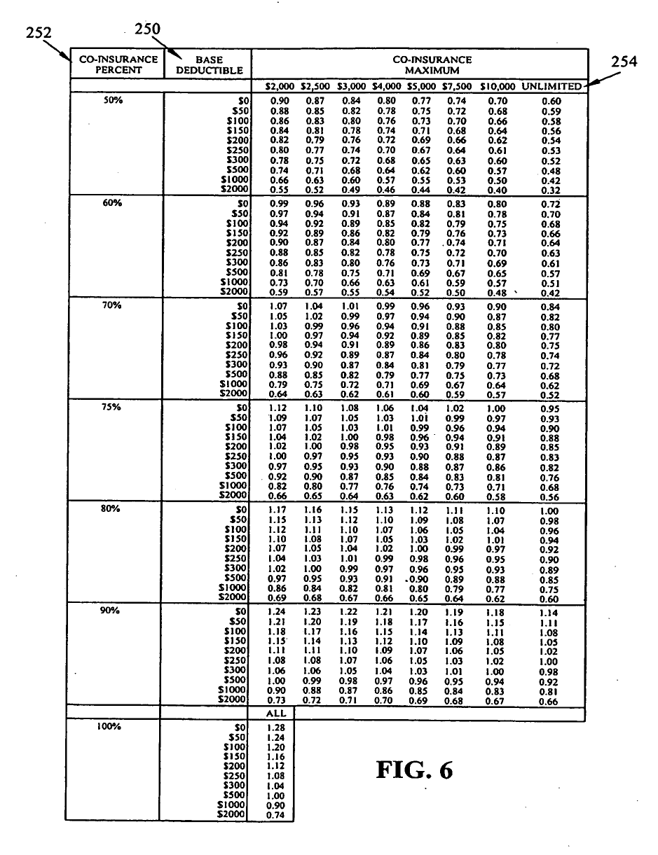

The relativity factors included in FIG. 1 are obtained through use of a conventional, off-the-shelf table of actuarial relativity factors such as that shown in FIG. 6, which indicates the cost, from an employer's perspective, of a particular plan design relative to the average plan design available in the United States which has a relativity factor of 1.00. As shown in FIG. 5, the relativity factor of a plan changes with changes in the deductible (column 250), the coinsurance percentage, (column 252) and the coinsurance maximum (row 254). Generally, plans that pay a higher coinsurance percentage have higher relativity factors, indicating a higher expense to the employer. Also, as the deductible decreases, the relativity factor increases. Finally, as the coinsurance maximum decreases, the relativity factor increases. Thus, any of a variety of plans can have a relativity factor of 1.00 with corresponding changes in each of these variables. For example, a plan with a coinsurance percentage of 80%, a deductible of $200, and a coinsurance maximum of $5,000 has a relativity factor of 1.00, as does a plan with an 80% coinsurance percentage, $300 deductible, and a $2,500 coinsurance maximum.

Referring back to FIG. 1, the relativity factor associated with the current plan (box 20) of the present example (i.e., a plan with a $250 deductible, 90% coinsurance percentage, and $7,500 coinsurance maximum) is 1.03 (cell 36), slightly more expensive from the employer's perspective than the average plan available in the United States. Under the proposed plan, year 1 (box 40), the relativity factor is 0.83 (cell 68) as provided by a conventional relativity factor look-up table such as that of FIG. 5. This relativity factor is adjusted for the inpatient copay of $250 as described above, resulting in a net factor of 0.81 (cell 66). Accordingly, the resulting relativity factor, indicating a plan which is substantially less expensive than the average United States plan, demonstrates a substantial shift in cost from the employer to the employees. More specifically, by taking the ratio of the change in relativity factors between the proposed plan (0.81) and the current plan (1.03), divided by the baseline relativity factor of the current plan, cost shift can be calculated as approximately 21% (i.e., ((1.03−0.81)/(1.05))*100=(0.22/1.03)*100=0.214*100=21.4%).

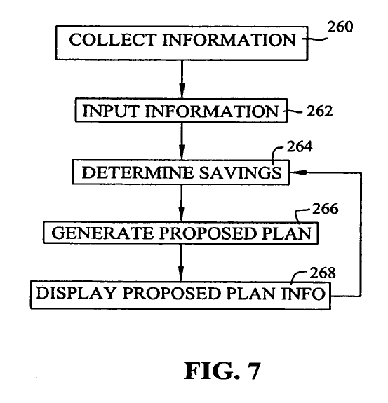

Referring now to FIG. 7, a method for presenting the above-described proposed plan includes the steps of collecting information describing the employer's current plan and number of employees covered under the current plan (step 260), inputting this current plan information into a computing device (step 262), determining the employer's desired savings level (step 264), generating a proposed plan including a primary component and a supplemental component (step 266), and displaying to the employer information describing the proposed plan and the resulting cost savings of the employer in dollars (step 268). The information describing the employer's current plan includes amounts of deductibles, coinsurance maximum, coinsurance percentage, and copays. The computing device referenced in step 262 may be any suitable computing device, such as a laptop computer, having a display and some sort of input device such as a mouse, keyboard, touchscreen , voice interface, etc. The computing device includes software capable of performing the calculation and display functions described herein.

It should be understood that, based on the employer's desired savings level, a person presenting the proposed plan, having knowledge of the impact of changes in deductible amounts, coinsurance maximums, coinsurance percentages, and copays, may readily change these variables to approach the desired savings level indicated by the employer. The computing device and software then generate and display screens, such as table 180 of FIG. 3, which clearly illustrate the cost impact of the proposed plan relative to the current plan. Additional screens, such as the contents of FIGS. 2, 4, and 5, may also be displayed to demonstrate to the employer the impact of the proposed plan on the employees.

As is also shown in FIG. 7, after the display and explanation of the proposed plan, if the employer wishes to adjust the target savings amount (upwardly or downwardly), steps 264, 266, and 268 may be repeated until the employer is satisfied with the target savings amount. In this manner, the method according to the present invention permits “on-the-fly” adjustments to proposed plans with corresponding displays to the employer of the financial impact the adjustments will have on the employer's costs and the employees' benefits.

It should further be understood that the above-described method may alternatively or additionally be applied retroactively to demonstrate to an employer the cost savings that would have been realized had the employer adopted a proposed plan at some time in the past. In this embodiment, past claims data is collected from the employer (step 260) for a previous time period, such as the past two years. Of course, any time period may be used. This historical claims data is then entered into the computing device (step 262). The software calculates the total annual cost to the employer of the past claims. A proposed plan is then generated at step 266 according to the principles described herein. The proposed plan is then applied to the historical claims data to determine the total annual cost over the given time period under the proposed plan. This total cost may then be compared to the actual total cost, and displayed at step 268. Changes to the proposed plan may then be made and re-applied to the historical data as desired and explained above. It should be understood that premiums associated with, for example, the supplemental component of the proposed plan may either be included or excluded from the cost comparison. If the premiums are included, then actual past premiums corresponding to comparable supplemental plans may be assumed, or current supplemental premiums may be adjusted (likely downwardly) to approximate premiums that would have been charged during the historical period of interest.

As indicated elsewhere herein, substantial deviations in healthcare consumption in large organizations are unlikely. Accordingly, for a large organization, a retrospective comparison of a current plan and a proposed plan may provide not only an accurate calculation of lost savings based on actual claims data, but also an accurate indication of future savings under the proposed plan.

When a party, such as a third party administrator (“TPA”) provides the above-described presentation to an employer who purchases a proposed plan, the TPA may receive a commission in the form of a percentage of the employer's savings or a percentage of any other plan component. Alternatively, the TPA may receive general fees on supplemental products and/or services. When the TPA sells a proposed plan to a broker, the TPA may receive a percentage of the broker's profit as a commission. Additionally, a TPA may actually administer the proposed plan, thereby receiving a fee for claims processing (see the $10 per employee per month fee in cell 57 of FIG. 1) as well as a commission on the employer's savings. It should be understood that any of the functions performed and services provided by a TPA as referenced throughout this disclosure (including in the claims) could alternatively be performed and provided by an insurance carrier.

In another embodiment of the invention, the cost savings described above resulting from a customized plan having primary and supplemental components is further enhanced by incorporating a method for optimizing healthcare services consumption such as the method described in co-pending patent application Ser. No. 10/313,370 hereinafter, “the '370 application”), filed Dec. 6, 2002, the entire disclosure of which is hereby expressly incorporated herein by reference. As fully described in the '370 application, this consumption optimization method (hereinafter, “the AHDI method” for American Health Data Institute, the company that provides the service) includes an analysis of the demographic and wellness characteristics of an employee population (including employees and employee family members), an analysis of the quality and cost efficiency of the practices of providers used by the employees, and intervention with employees and providers to improve the overall health of the employees, the practices of the providers, and the cost efficiency of the primary component of the employer's healthcare plan.

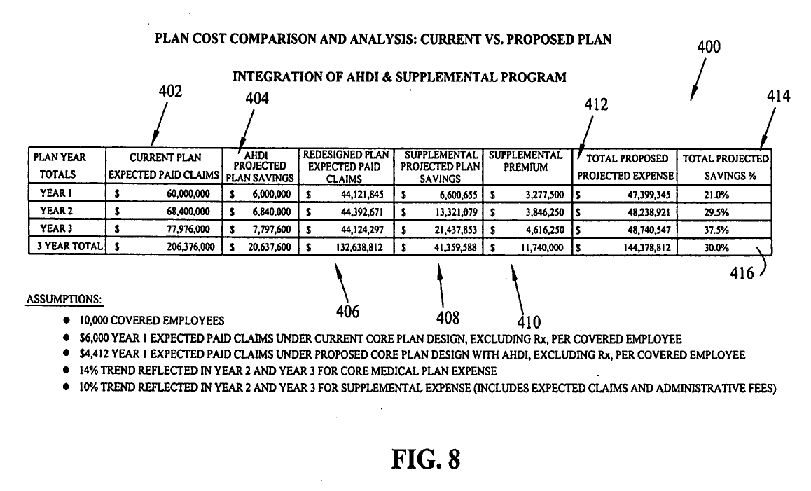

As shown in FIG. 1, the employer in the above-described example can reduce the cost of the primary component of the proposed plan for the first year from $49,024,272 cell 42) to $44,121,845 cell 43) by incorporating the AHDI method. Table 400 of FIG. 8, which is similar table 180 of FIG. 3, shows a summary of the combined financial impact of the AHDI method and the proposed plan over a three-year period. The current plan costs listed in column 402 are the same as those listed in column 184 of table 180. Column 404 shows the impact of the AHDI method, which results in a projected 10% savings by proactively managing the proposed plan's illness burden and encouraging use of the highest quality, most cost effective healthcare providers in the manner described in the '370 application. Column 406 lists the expected costs of the primary plan, based on the reduced and more cost effective utilization driven by the AHDI method. In other words, the costs listed in column 406 are based on the current plan expected costs of column 402 reduced by the AHDI savings of column 404. Column 408 lists the expected savings from adopting the proposed plan, as fully described above. Column 410 lists the premiums for the supplemental component of the proposed plan, which are based on the primary plan costs of column 406. The total cost of the proposed plan listed in column 412 is simply the sum of the primary plan costs of column 406 and the supplemental premium of column 410.

Contrasting table 400 of FIG. 8 with table 180 of FIG. 3, it is shown that the employer's savings for the first year under the proposed plan increases from 12.8% to 21.0% (column 414). This increased savings is a direct result of implementation of the AHDI method to reduce the expected paid claims of the current plan (which serves as the baseline for design of the proposed plan) by 10%. As shown in column 414 of FIG. 8, the employer's total savings increases for subsequent years to provide a three-year average savings of 30.0% (cell 416).

In yet another embodiment, an employer may alternatively allocate some or all of the savings realized through implementation of a proposed plan as described above (either with or without incorporating the AHDI method) to individual and/or family benefit accounts (hereinafter referred to as “benefit banks”), which may be accessed and applied to additional insurance products (or other products) as selected by the employees. For example, if an employer saves an annual amount of $1,000,000 by implementing a proposed plan, the employer may allocate $500,000 of that savings to employee benefit banks. The employer may allocate the $500,000 according to a formula established by the employer, such as $100 per year for individual employees and $200 per year for employees covered by a family plan. In such an example, an individual employee has access to $100 per year to purchase, for example, additional life insurance, accidental death and disability insurance, or other products.

The benefit banks are administered by the employer or a TPA. In either case, each employee may be provided a “menu” of benefits options that the employee may purchase using funds available in the employee's benefit bank. Employees may be provided a periodic statement of the activity corresponding to their benefit banks, and may be permitted to redirect benefit bank funds at selected intervals, or at any time, according to the rules associated with the benefit banks. It should be understood that the benefit banks may also be maintained on a secured-access server, as are well-known in the art, thereby enabling employees to view the status of their benefit banks, allocate and/or redirect funds, or perform other transactions over a network such as the internet. The TPA responsible for either the primary component of the proposed plan or the supplemental component of the proposed plan (or both) may also administer the additional products purchased with the benefit bank funds.

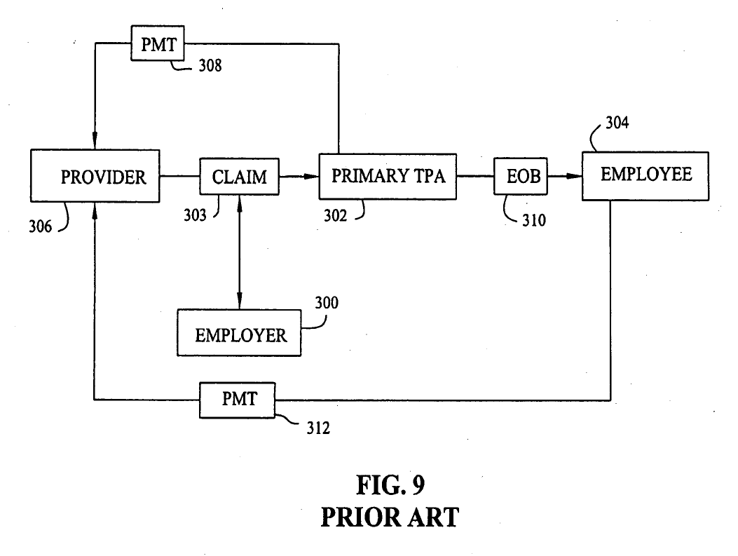

After a proposed plan is designed in the manner described above, various options exist for administering the plan and processing claims. FIG. 9 shows a highly generalized relationship among participants in a conventional employer provided healthcare situation. In this example, the employer 300 is self-insured and provides funds, based on predicted healthcare costs, to a primary third party administrator 302 of healthcare benefits for paying employee healthcare claims. Of course, also involved in this relationship are the healthcare consumer, employee 304, and the healthcare provider 306 (e.g., a physician or a facility such as a hospital, laboratory, etc.). In a typical transaction associated with a healthcare claim, employee 304 visits provider 306 to obtain healthcare services and/or products. For simplicity, this description collectively refers to services and products as healthcare services. Provider 306 submits a claim 303 in an amount corresponding to the cost of the services to either the preferred provider organization (“PPO”) (not shown) or TPA 302 handling the employer's 300 healthcare funds. As is well known in the art, PPOs (or alternatively TPAs) typically discount or reprice the claimed charges based on an agreement between provider 306 and the PPO. The repriced claim is then submitted to TPA 302 for payment if the claim was originally submitted to the PPO. TPA 302 then accesses funds in the healthcare account of employer 300 to pay provider 306 the repriced claim amounts (payment 308).

Alternatively, if the claim was originally submitted to primary TPA 302, then primary TPA 302 simply generates the repriced claim, and accesses the account of employer 300 to pay provider 306 the repriced claim amount (payment 308). In either case, primary TPA 302 then also informs employee 304 (via an explanation of benefits (“EOB”) document (EOB 310)) of the patient's payment responsibility after application of the terms of the underlying benefit plan when it does not pay 100% of eligible charges. Employee 304 then sends a payment (payment 312) to provider 306.

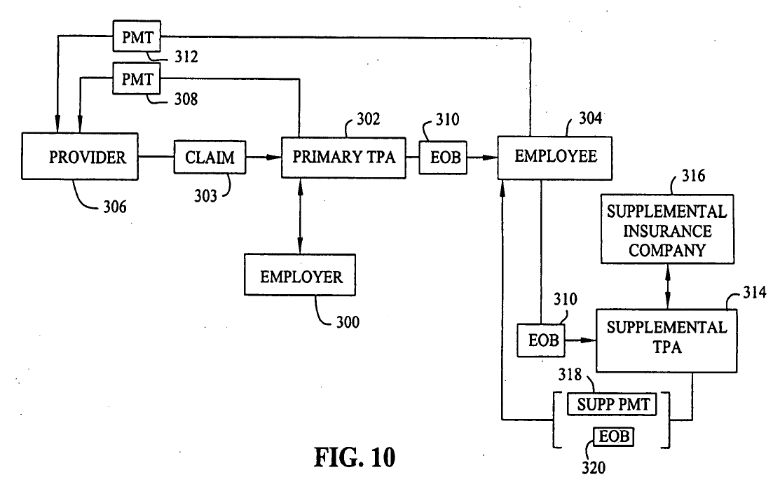

FIG. 10 depicts one embodiment of a structure for processing claims submitted under a proposed plan according to the present invention. The structure is the same as FIG. 9, except that a supplemental TPA 314 and a supplemental insurance provider 316 are involved in processing the supplemental component of the proposed plan. In this embodiment, after employee 304 receives EOB 310 from primary TPA 302, employee 304 forwards EOB 310 to supplemental TPA 314. Supplemental TPA 314 then accesses funds (if any) corresponding to the supplemental insurance coverage of employee 304. These funds (supplemental payment 318) are provided to employee 304, along with an EOB corresponding to the supplemental component of the proposed plan (supplemental EOB 320). Employee 304 may then send payment (payment 312) to provider 306 for the remaining portion of the repriced claim. As should be understood from the foregoing, supplemental payment 318 may be sufficient to entirely cover payment 312, or at least reduce significantly. the amount of payment 312 that employee 304 must pay as an out-of-pocket expense.

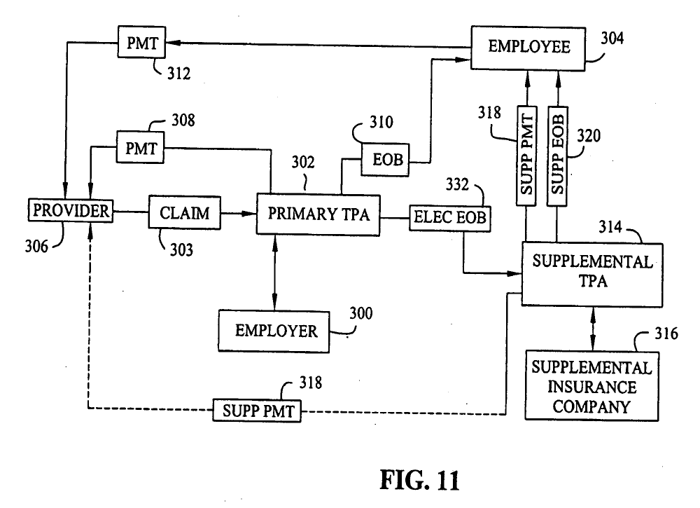

FIG. 11 shows yet another embodiment of a structure for processing claims submitted under a proposed plan according to the present invention. In this structure, provider 306 submits claim 303 to primary TPA 302, which reprices the claim, access the healthcare account of employer 300, and sends payment 308 to provider 306 in an amount corresponding to the parameters of the primary component of the proposed plan. Primary TPA 302 also sends primary EOB 310 to employee 304, and an electronic EOB 332 to supplemental TPA 314. It should be understood that electronic EOBs 332 may be delivered automatically, on a periodic basis such as daily, using conventional batch processing methods. Supplemental TPA 314 then accesses the funds (if any) corresponding to the supplemental coverage of employee 304 provided by supplemental insurance provider 316. Next, supplemental TPA 314 forwards supplemental EOB 320 to employee 304, along with supplemental payment 318. It should be understood that, as compared to the structure of FIG. 10, the structure of FIG. 11 essentially eliminates all of employee's 304 responsibility for processing the claim. Employee 304 need only mail payment 312 to provider 306, which may correspond directly to supplemental payment 318 provided to employee 304 by supplemental TPA 314 as described above. Alternatively, supplemental TPA 314 may send supplemental payment 318 directly to provider 306 (where there has been an assignment of benefits) as indicated by the dotted line in FIG. 11. In this case, if supplemental payment 318 from supplemental TPA 314 covers the remaining repriced claim amount after payment 308, then employee 304 does nothing to process or pay the claim. Supplemental EOB 320 will explain to employee 304 that the claim was paid on his or her behalf. Otherwise, supplemental EOB 320 will explain that a portion of the remaining claim was paid, but that employee is still responsible for a payment as an out-of-pocket expense. In this instance, employee 304 would pay payment 312.

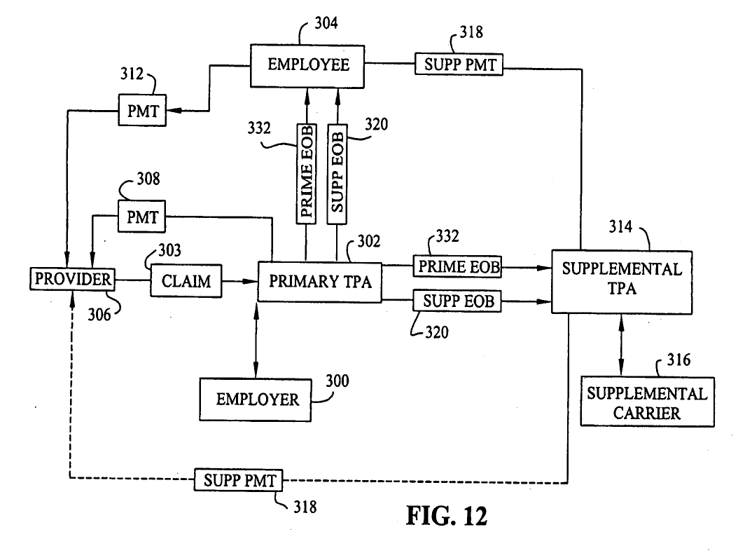

The embodiment of FIG. 12 differs from the embodiment of FIG. 11 in that employee 304 receives a single communication including primary EOB 332 and supplemental EOB 320. More specifically, primary TPA 302 generates primary EOB 332 as described above, and electronically forwards primary EOB 332 to supplemental TPA 314. Supplemental TPA 314 generates supplemental EOB 320 as described above, and electronically forwards supplemental EOB 320 to primary TPA 302. Primary TPA 302 then sends a single communication including primary EOB 332 and supplemental EOB 320 to employee 304. Supplemental TPA 314 also forwards supplemental payment 318 either to employee 304 or to provider 306 (as shown in dotted lines) depending upon the arrangement agreed to by employee 304. Employee 304 then sends payment 312 to provider 306 as described above. Alternatively, supplemental TPA 314 may forward supplemental payment 318 to primary TPA 302, who provides one communication to employee 304 including primary EOB 332, supplemental EOB 320, and supplemental payment 318.

It should be understood that any of the communications described above may be sent by mail, by facsimile, electronically, such as an email or other electronic communication, or any combination thereof. Additionally, any of the communications may be facilitated through use of a third party mailing service.

In yet another embodiment of a claims processing structure according to the present invention, either the primary TPA 302 or the supplemental TPA 314 may maintain flexible spending plans (“flex plans”) for employees for use in paying out-of-pocket expenses associated with healthcare claims. Assuming supplemental TPA 314 administers the flex plan in such an embodiment, supplemental TPA 314 first determines the amount (if any) of the claim remaining after payment 308 by primary TPA 302 that may be covered by the supplemental coverage of employee 304. If, after the supplemental benefits are applied to the remaining claim amount, portions of the amount are not covered, then supplemental TPA 314 may access the flex plan of employee 304, withdraw an amount (if available) sufficient to cover the balance, and provide a flex plan statement along with supplemental EOB 320 to primary TPA 302 for communication to employee 304. The amount withdrawn from the flex plan may be either sent directly to provider 306 or sent to employee 304 as described above.

Finally, it should be understood that the functions of primary TPA 302 and supplemental TPA 314 may be combined in a single TPA (not shown). Moreover, if this combined TPA also administers the flex plans of employees 304, then all of the primary component processing, supplemental component processing, and flex plan processing is carried out by a single entity.

In another embodiment of the present invention, the supplemental component of the proposed plan is not an insurance policy. Instead, the supplemental component is self-funded by employer 300, which further reduces the costs incurred by employer 300. More specifically, using historical claims data of employer 300, a projected need for supplemental benefits can readily be determined using the principles described herein and other principles understood by those skilled in the art. After the supplemental benefits need is determined, employer 300 can set aside appropriate funds for payment of supplemental benefits in a TPA managed supplemental benefits account described in a self-funded supplemental document. In this manner, instead of paying premiums for supplemental insurance benefits which may exceed the benefits provided under by the supplemental insurance, employer 300 may retain the funds to use in any manner the employer desires, so long as the employer is able to pay supplemental benefits on a pay-as-you-go basis or otherwise. As is well understood in the art, for very large covered populations that are typically associated with large employers such as government entities, public corporations, etc., historical claims experience is a very accurate predictor of future claims. If future claims can be accurately predicted, then employer 300 should be able self-fund a supplemental component of a proposed plan with acceptable risk levels to employer 300. By assuming the risk of the supplemental component in this manner, employer 300 will essentially enjoy a cost savings related to the profit a supplemental insurance provider would receive as a result of assuming this risk.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A method of demonstrating the affect of changes to a healthcare plan, including the steps of:
inputting information related to a current healthcare plan into a computing device having a display and an input device, the information related to the current healthcare plan being inputted with the input device;
generating with the computing device characteristics of a proposed healthcare plan based on the information related to the current healthcare plan;
determining with the computing device a defined benefits recipient costs characteristic of a primary component of the proposed healthcare plan;
determining with the computing device at least one benefit characteristic of a supplemental component of the proposed healthcare plan to offset the defined benefits recipient costs characteristic of the primary component of the proposed healthcare plan; and
displaying the characteristics of the proposed healthcare plan on the display.

2. The method of claim 1, further including the step of calculating with the computing device a savings level of the proposed healthcare plan relative to the current healthcare plan and displaying the savings level on the display.

3. The method of claim 2, further including the steps of generating and displaying a modified proposed healthcare plan in response to the calculating step.

4. The method of claim 1, wherein the proposed healthcare plan includes a deductible, a coinsurance maximum, a coinsurance percentage, and a inpatient copayment.

5. The method of claim 1, wherein the current healthcare plan and the proposed healthcare plan each include a maximum out-of-pocket expense for an individual and a maximum out-of-pocket expense for a family.

6. A method of demonstrating the affect of changes to a healthcare plan, including the steps of:
inputting information related to a current healthcare plan having a maximum out-of-pocket expense for an individual and a maximum out-of-pocket expense for a family into a computing device having a display and an input device, the information related to the current healthcare plan being inputted with the input device;
generating with the computing device characteristics of a proposed healthcare plan based on the information related to the current healthcare plan, the proposed healthcare plan including a primary component and a supplemental component;
determining with the computing device a maximum out-of-pocket expense for an individual and a maximum out-of-pocket expense for a family for the proposed healthcare plan, the individual maximum out-of-pocket expense under the proposed healthcare plan being less than the maximum out-of-pocket expense under the current healthcare plan for an annual claims amount that is less than or equal to an average annual claims amount in the United States; and
displaying characteristics of the current healthcare plan and the proposed healthcare plan on the display, the displayed characteristics of the current healthcare plan and the proposed healthcare plan each including the maximum out-of-pocket expense for an individual and the maximum out-of-pocket expense for a family.

7. The method of claim 1, wherein the primary component of the proposed healthcare plan is self-funded.

8. The method of claim 1, wherein the primary component of the proposed healthcare plan is fully-insured.

9. The method of claim 1, wherein the primary component of the proposed healthcare plan, as compared to the current healthcare plan, represents a shift of cost from a benefits provider to a benefits recipient.

10. The method of claim 9, wherein the supplemental component of the proposed healthcare plan reduces the cost shift.

11. The method of claim 1, wherein the proposed healthcare plan includes cost projections over a time period that is greater than one year.

12. The method of claim 1, wherein the proposed healthcare plan includes cost projections over a three-year time period.

13. The method of claim 12, wherein cost projections associated with the primary component of the proposed healthcare plan are substantially constant over the three year period.

14. The method of claim 1, wherein the displaying step includes the step of displaying a savings amount of the proposed healthcare plan relative to the current healthcare plan expressed in dollars.

15. The method of claim 14, wherein the displaying step further includes the step of displaying a plurality of savings amounts of the proposed healthcare plan relative to the current healthcare plan, each savings amount being expressed in dollars and corresponding to a different one-year time period.

16. The method of claim 14, wherein the savings amount is also expressed as a percentage of a cost of the current plan.

17. The method of claim 1, wherein the generating step includes the step of defining with the computing device the proposed healthcare plan such that, for a majority of the benefits recipients under the proposed healthcare plan, a projected annual cost of the proposed healthcare plan is less than a projected annual cost of the current healthcare plan.

18. The method of claim 1, wherein the generating step includes the step of defining with the computing device the proposed healthcare plan such that a relativity factor of the proposed healthcare plan is less than a relativity factor of the current healthcare plan.

19. The method of claim 1, wherein the computing device is a laptop computer.

20. A method of demonstrating the affect of changes to a healthcare plan, including the steps of:
inputting information describing characteristics of a current healthcare plan into a computing device having a display and an input device, the information related to the current healthcare plan being inputted with the input device;
generating with the computing device a proposed healthcare plan including a primary component and a supplemental component;
computing with the computing device a cost characteristic of the proposed healthcare plan to a benefits recipient such that the cost characteristic is a first amount for a plurality of claims processed in a first sequence and a second amount for the plurality of claims processed in a second sequence that is different from the first sequence, the second amount being different from the first amount; and
displaying the cost characteristic of the proposed healthcare plan on the display.

21. A method of demonstrating the affect of changes to a healthcare plan, including the steps of:
inputting information describing characteristics of a current healthcare plan into a computing device having a display and an input device, the information related to the current healthcare plan being inputted with the input device;
generating with the computing device a proposed healthcare plan based on the information, the proposed healthcare plan including a primary component and a supplemental component;
computing with the computing device a first cost characteristic of the proposed healthcare plan to a benefits provider of the proposed healthcare plan such that the first cost characteristic is the same for a plurality of claims processed for a benefits recipient under the proposed healthcare plan regardless of whether the plurality of claims are processed in a first sequence or a second sequence;
computing with the computing device a second cost characteristic of the proposed healthcare plan to the benefits recipient under the proposed healthcare plan such that the second cost characteristic is a first amount for the plurality of claims processed in the first sequence and a second amount for the plurality of claims processed in the second sequence that is different from the first sequence, the second amount being different from the first amount; and
displaying the first and the second cost characteristics of the proposed healthcare plan on the display.
